(19) United States
(12) Patent Application Publication
(10) Pub. No.: US 2015/0307162 A1
(43) Pub. Date: Oct. 29, 2015

(54) MOBILE FLOATING WATER TREATMENT SYSTEM AND METHOD

(71) Applicant: Wasserwerk, Inc., Columbia, MO (US)

(72) Inventor: Wayne R. Hawks, Columbia, MO (US)

(21) Appl. No.: 14/699,975

(22) Filed: Apr. 29, 2015

Related U.S. Application Data
(60) Provisional application No. 61/985,882, filed on Apr. 29, 2014.

(51) Int. Cl. B63B 35/32; B63B 35/66; B63B 21/62; B01D 21/00; B63B 35/28; C02F 1/40; B01D 17/02; B63B 25/00; B63B 57/00

(52) U.S. Cl. CPC B63B 35/32; B63B 25/006; B63B 35/66; B63B 21/62; B63B 57/00; B63B 35/28; C02F 1/40; B01D 17/0211; B01D 21/0042; B63B 2035/002

(57) ABSTRACT

A mobile floating water treatment system comprising a plurality of floating barges coupled together wherein one or more barges includes at least one baffle through which water passes for treatment purposes. The baffle may include includes a substrate material suitable for treating contaminated water. The baffle may be selectively raised from an interior tank of the barges in order to add or subtract substrate material. The substrate material may include at least one of calcium carbonate, silicon dioxide, cadmium and bismuth. The mobile floating water treatment system may also comprise a tugboat for mobilizing the barges and a dredge for collecting contaminated water and distributing the water to the barges. The water treatment system may include one or more vessel or railcar located adjacent said barges into which contaminants separated from said water may be diverted for storage, transportation and disposal.

### CROSS-REFERENCE TO RELATED APPLICATIONS

This application claims the benefit of U.S. Provisional Patent Application No. 61/985,882 filed Apr. 29, 2014, the entire disclosure of which is hereby incorporated by reference.

### BACKGROUND OF THE INVENTION

Pollution of surface waters is a pressing issue worldwide. The water of many rivers, lakes, streams, canals, ponds and other waterways and reservoirs has become polluted to the point where it cannot support animal life and is entirely unsafe for consumption. A substantial portion of this pollution can be attributed to industrial and manufacturing processes, fossil fuel extraction and mining practices. In particular, polluted waters that are discharged into waterways and reservoirs may contain a wide variety of pollutants. Such pollutants include industrial waste, oil, coal slurry, coal ash, fly ash, bottom ash, toxic and heavy metals (including arsenic, beryllium, cadmium, chromium, cobalt, lead, manganese, mercury, molybdenum, selenium, strontium, thallium and vanadium, among others), radioactive materials, carcinogens, polychlorinated biphenyl (PCB), methylcyclohexanemethanol (MCHM), dioxins, sewage, bacteria, microbes, and other various pollutants. Further yet, these pollutants may become naturally transported from one geographical area to another and may also infiltrate into groundwater sources.

Accordingly, a need exists for a flexible and scalable water treatment system capable of treating surface waters contained in waterways and reservoirs. A particular need exists for a water treatment system that is suitable for treating water in situ; for example, water that is flowing in a river.

### SUMMARY OF THE INVENTION

### DESCRIPTION OF THE SEVERAL VIEWS OF THE DRAWINGS

In the accompanying drawings, which form a part of the specification and are to be read in conjunction therewith in which like reference numerals are used to indicate like or similar parts in the various views:

FIG. 1 is a schematic plan view of a water treatment system including a dredge, a plurality of barges and a tugboat in accordance with one embodiment of the present invention;

FIG. 2 is a schematic plan view of a tugboat and dredge system in accordance with one embodiment of the present invention;

FIG. 3 is a schematic side view of a tugboat having a vacuum system in accordance with one embodiment of the present invention;

FIG. 4 is a schematic left side view of a water treatment system including a plurality of barges in accordance with one embodiment of the present invention;

FIG. 5 is a schematic sectional side view of front rake barge of a water treatment system in accordance with one embodiment of the present invention;

FIG. 6 is a schematic sectional side view of a first intermediate box barge of a water treatment system in accordance with one embodiment of the present invention;

FIG. 7 is a schematic sectional side view of a second intermediate box barge of a water treatment system in accordance with one embodiment of the present invention; and

FIG. 8 is a schematic sectional side view of rear rake barge of a water treatment system in accordance with one embodiment of the present invention.

### DETAILED DESCRIPTION OF THE INVENTION

The invention will now be described with reference to the drawing figures, in which like reference numerals refer to like parts throughout. For purposes of clarity in illustrating the characteristics of the present invention, proportional relationships of the elements have not necessarily been maintained in the drawing figures.

The following detailed description of the invention references specific embodiments in which the invention can be practiced. The embodiments are intended to describe aspects of the invention in sufficient detail to enable those skilled in the art to practice the invention. Other embodiments can be utilized and changes can be made without departing from the scope of the present invention. The present invention is defined by the appended claims and the description is, therefore, not to be taken in a limiting sense and shall not limit the scope of equivalents to which such claims are entitled.

The entire disclosures of (a) issued U.S. Pat. No. 8,974,672, filed on August 26, 2011 to Wayne R. Hawks entitled “Self-Contained Irrigation Treatment System,” (b) issued U.S. Pat. No. 9,011,681, filed on Sep. 26, 2012 to Wayne R. Hawks entitled “Self-Contained Irrigation Treatment System,” (c) pending U.S. patent application Ser. No. 14/208,005, filed on Mar. 13, 2014 to Wayne R. Hawks entitled “System and Method for Treating Contaminated Water” are all incorporated in their entirety herein by reference.

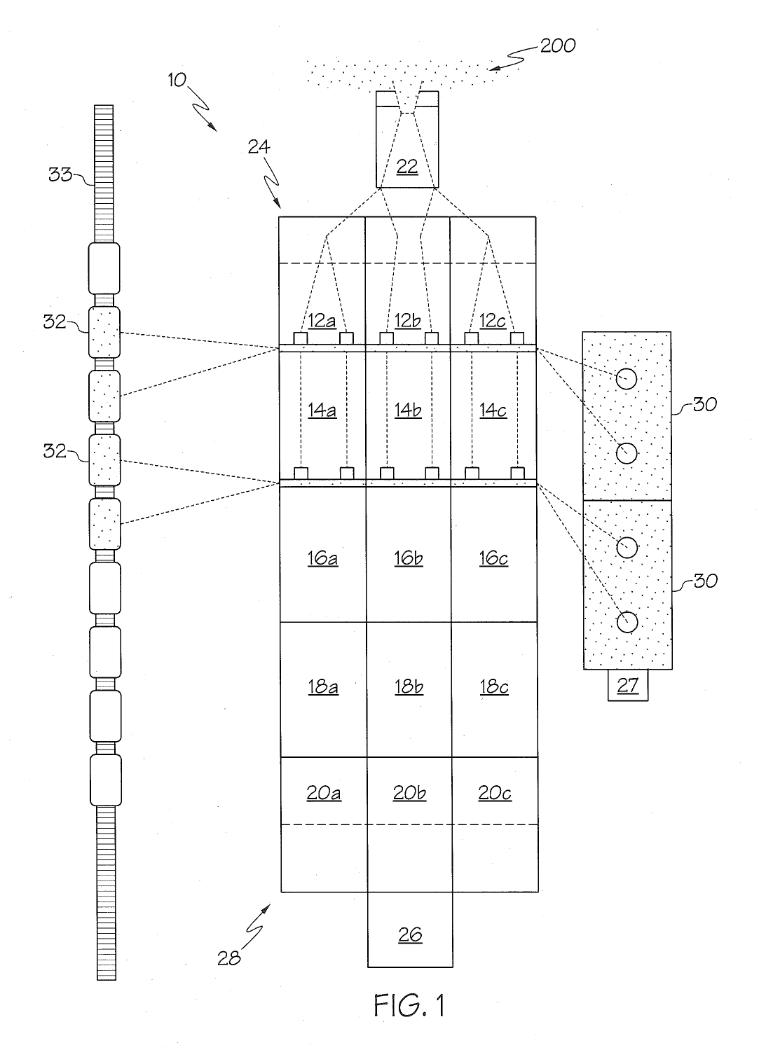

FIG. 1 generally illustrates one embodiment of the mobile floating water treatment system 10 of the present invention comprising a plurality of barges 12a-20c. The system 10 may optionally include a dredge 22 or suction device in communication with the system's 10 inlet end 24 and a tugboat 26 located proximate the system's outlet end 28. As depicted, the system 10 may be connected to one or more other barges, vessels 30 and/or railcars 32 into which contaminants may be held and later transported. As will be discussed in further detail below, contaminated water enters the system 10 at the inlet end 24 and exits the system 10 at the outlet end 28. Vessels 30 may be carried by a tugboat 27.

As depicted in the embodiment shown in FIG. 1, the system 10 includes fifteen (15) barges 12a-20c. In the embodiment, the barges 12a-20c are arranged in a configuration that is three (3) barges wide and five (5) barged deep. However, it will be appreciated that other numbers and configurations of barges are within the scope of the present invention. For example, in another embodiment (not shown), the system 10 may include forty (40) barges wherein the barges are arranged so that the system is five (5) barges wide and eight (8) barges deep. Multiple barges or systems may be optionally placed side-by-side across substantially the entire width of a body of water (e.g., a river). It will be understood that the system 10 may be mobile or may be held in place within a body of water.

The barges 12a-20c may be a combination of two types of barges, namely, rake barges 12a-12c and 20a-20c and box barges 14a-18c. As demonstrated, the rake barges 12a-12c and 20a-20c are placed at the inlet and outlet ends 24 and 28 of the system 10 and the box barges 14a-18c are placed therebetween. The rake barges 12a-12c and 20a-20c may each be constructed of a hull having a slanted or angled wall 34 located at their bow or stern, respectively. The rake barges 12a-12c and 20a-20c may have any length, width, and depth. In one embodiment, rake barges 12a-12c and 20a-20c having a length of around 195 feet long, a width of around 35 feet, and a cargo hold depth of around 13 feet. The box barges 14a-18c are generally box-shaped having upright walls at their bow and stern. The box barges 14a-18c may also have any length, width, and depth. In one embodiment, box barges 14a-18c may have a length of around 200 feet long, a width of around 35 feet wide, and a cargo hold depth of around 13 feet. In the illustrated embodiment, the barges 12a-20c are arranged and connected such that water being treated flows from the front barges 12a-12c to the first intermediate barges 14a-14c to the second intermediate barges 16a-16c to the third intermediate barges 18a-18c to the rear barges 20a-20c and then optionally to the tugboat 26. Barges 12a-14c may be adapted for removing the most substantial contaminants 200 from the water. Such substantial contaminants may include, but are not limited to, oil, benzene molecules, dioxins, polychlorinated biphenyl (PCB), heavy metals and large solids from the water. Depending upon the concentration of contaminants, barges 18a-20c may be adapted for subsequent treatment and polishing of the water.

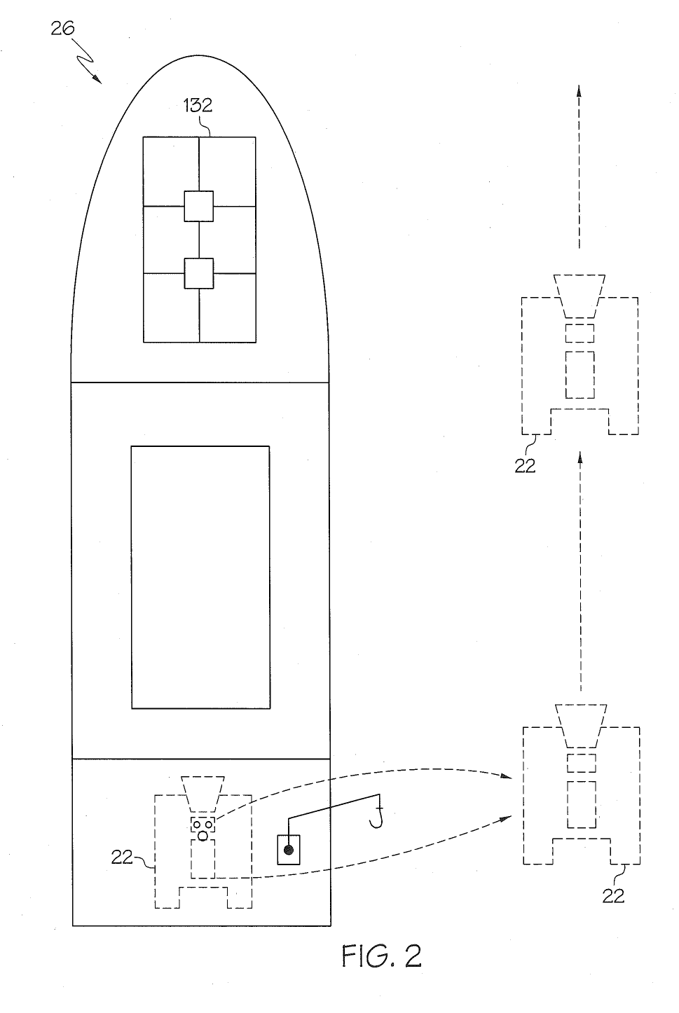

FIG. 2 illustrates one configuration of tugboat 26 having a vacuum system 132 disposed thereon. In addition, tugboat 26 may carry dredge 22 in such a manner that dredge 22 may be transferred from tugboat 26 to the water surface. Dredge 22 will then be able to move to the front of the barge assembly for collecting contaminates 200 from the water to be distributed to the present mobile floating water treatment system 10 for treatment (as shown in FIG. 1).

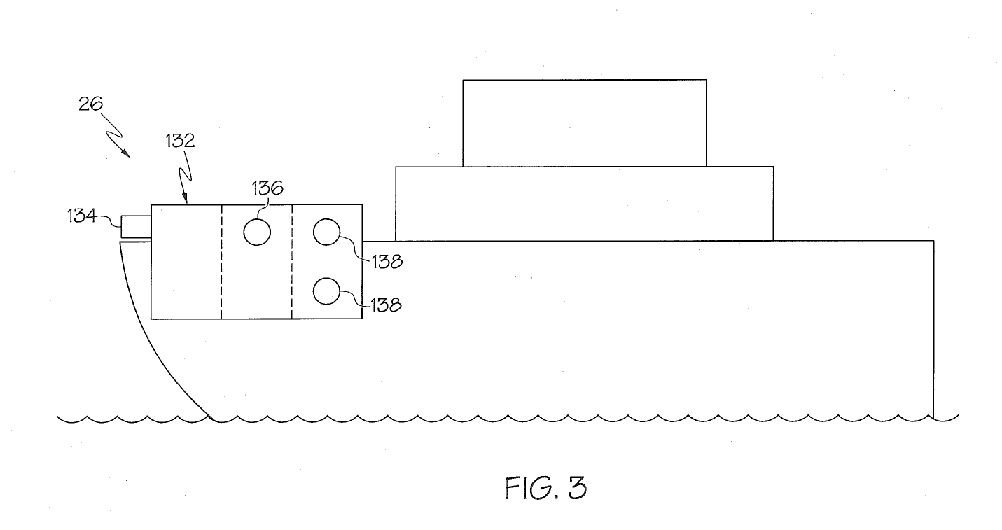

FIG. 3 illustrates a side view of tugboat 26 showing vacuum system 132 comprising one or more inlet port 134 for water flowing into the vacuum system 132, and a first port 136 and one or more second ports 138 for discharge of the water out of the vacuum system 132. Operation of the vacuum system as it applies to the present invention is described in more detail below.

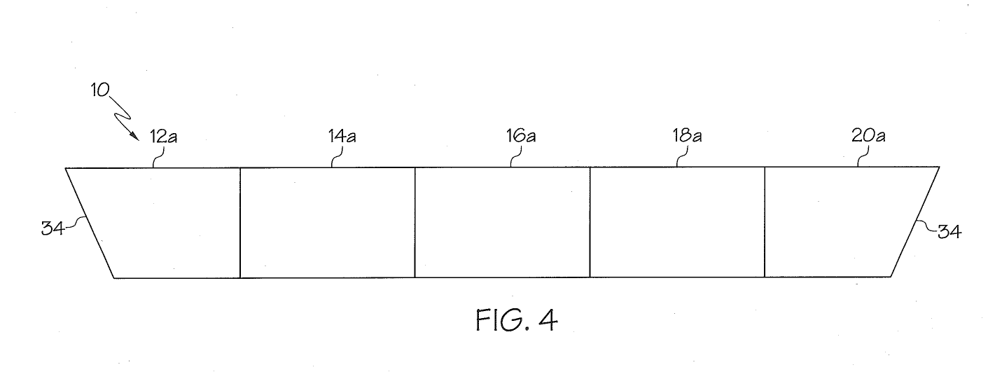

FIG. 4 illustrates a side view of one embodiment of a barge assembly of the present mobile floating water treatment system 10. As shown, the sequential order of the barges in this embodiment are as follows: front barge 12a, first intermediate barges 14a, second intermediate barge 16a, third intermediate barge 18a, and rear barge 20a.

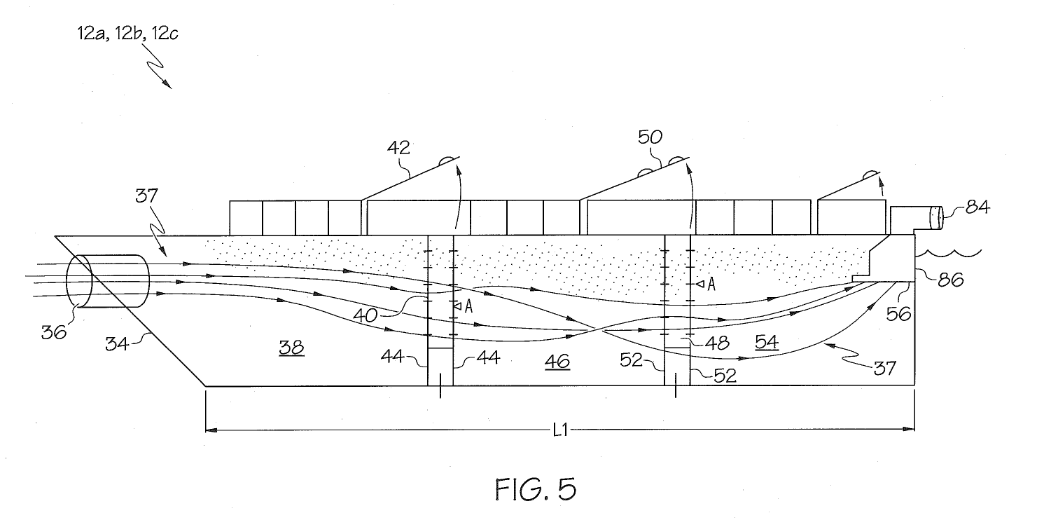

FIG. 5 demonstrates the construction of the front rake barges 12a-12c. As shown, each of the front rake barges 12a-12c includes at least one inlet port 36 through which contaminated water 37 enters the barges 12a-12c. The inlet ports 36 may be in fluid communication with a dredge 22 located at the floor of the body of water and/or another suction or skimming devices located at the top surface of the water or between the top surface of the water and the floor of the body of water. The dredge may be an IMS 7012 Versi-Dredge, an IMS 5012 Versi-Dredge, an SRS Crisafulli or any other suitable dredge. Depending upon the specific gravity of the contaminants, the contaminants may be located at various depths in the water. For example, some contaminants (e.g., heavy metals) may have a specific gravity greater than water and are therefore located on or near the floor of the body of water, whereas, some contaminants (e.g., petroleum products) may have a specific gravity less than water and are therefore located on or near the top surface of the water and other contaminants may have a specific gravity that is similar to water and are therefore located between the top surface of the water and the floor of the body of water. Depending upon the types (and depths) of contaminants present in the water, suction or intake devices, nozzles and/or hoses may be located at various depths in order to pull in contaminants located at the various depths. The suction devices may be adjusted vertically and maintained at a generally desired height through the intake or discharge of ballast. In any case, the suction devices may be in fluid communication with the inlet ports 36 of the system 10.

As depicted in FIG. 5, upon entering the front barges 12a-12c through the inlet ports 36, the contaminated water 37 passes through a first tank 38 and then a first baffle 40 that can contain one or more substrates, such as silicon dioxide (SiO₂), calcium carbonate (CaCO₃). cadmium (Cd) and bismuth-210 (Bi). The first baffle 40 can be moved up and down and may be raised from the interiors of the barges 12a-12c through hatches 42. In addition, one or more gates 44 located underneath the first baffle 40 may be raised so that the water 37 is diverted underneath the first baffle 40. Upon passing through or underneath the first baffle 40, the water 37 passes into a second tank 46 and then through a second baffle 48 which may also contain one or more substrates like the first baffle 40. Like the first baffle 40, the second baffle 48 can be raised and lowered and may be raised from the interiors of the barges 12a-12c through hatches 50. Again, gates 52 located underneath the second baffles 40 may be raised and lowered so that the water can be diverted through and/or underneath the second baffle 48. Upon passing through or underneath the second baffle 48, the water 37 passes into a third tank 54. The third tank 54 can include oil snouts 56. As water 37 passes through the oil snouts 56, the oil snouts 56 separate and capture oil and benzene (C₆H₆) molecules from the water 37. The oil and benzene collected by the oil snouts 56 may be diverted, via vacuum pressure, from outlet ports 84 to the side barges, vessels 30 and/or railcars 32 for storage, transportation, disposal and/or reuse (see FIG. 1). The water 37 then exits the barges 12a-12c through outlet ports 86, which are in communication with inlet ports 58 of the first intermediate barges 14a-14c.

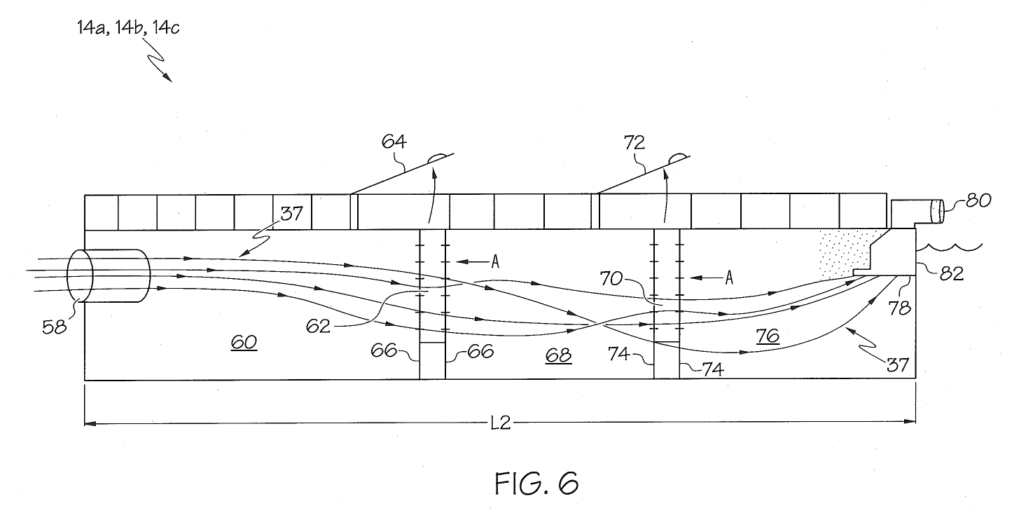

FIG. 6 illustrates the first intermediate barges 14a-14c into which the water 37 flows upon exiting the front barges 12a-12c. The construction of the first intermediate barges 14a-14c may be similar in nature to the construction of the front barges 12a-12c. As such, the water 37 in barges 14a-14c passes through a fourth tank 60 and then a third baffle 62 that can contain one or more substrates, such as silicon dioxide (SiO₂), calcium carbonate (CaCO₃), cadmium (Cd) and/or Bismuth-210 (Bi). The third baffles 62 can also be moved up and down and may be raised from the interiors of the barges 14a-14c through hatch 64. Alternatively, one or more gate 66 located underneath third baffle 62 may be raised so that the water 37 may be diverted underneath the third baffle 66. Upon passing through or underneath the third baffle 62, the water 37 passes into a fifth tank 68 and then through a fourth baffle 68 which may also contain one or more substrates like the other baffles 40, 48 and 62. Like the other baffles 40, 48 and 62, the fourth baffle 70 can be raised and lowered and may be raised from the interior of barges 14a-14c through one or more hatch 72. Again, one or more gate 74 located underneath the fourth baffle 70 may be moved to divert water 37 underneath the fourth baffle 70. Upon passing through or underneath the fourth baffle 70, the water 37 passes into a sixth tank 76. Like the third tank of barges 12a-12c, the sixth tank 76 may include one or more oil snouts 78. As water 37 passes through the oil snouts 78, the oil snouts 78 separate and capture oil and benzene (C₆H₆) molecules from the water 37. As shown in FIG. 1, the oil and benzene collected by the oil snouts 78 may be diverted, via vacuum pressure, from outlet ports 80 to the side barges, vessels 30 and/or railcars 32 for storage, transportation, disposal and/or reuse. The water 37 exits the barges 14a-14c through one or more outlet ports 82, which are in fluid communication with one or more inlet ports 88 of the second intermediate barges 16a-16c.

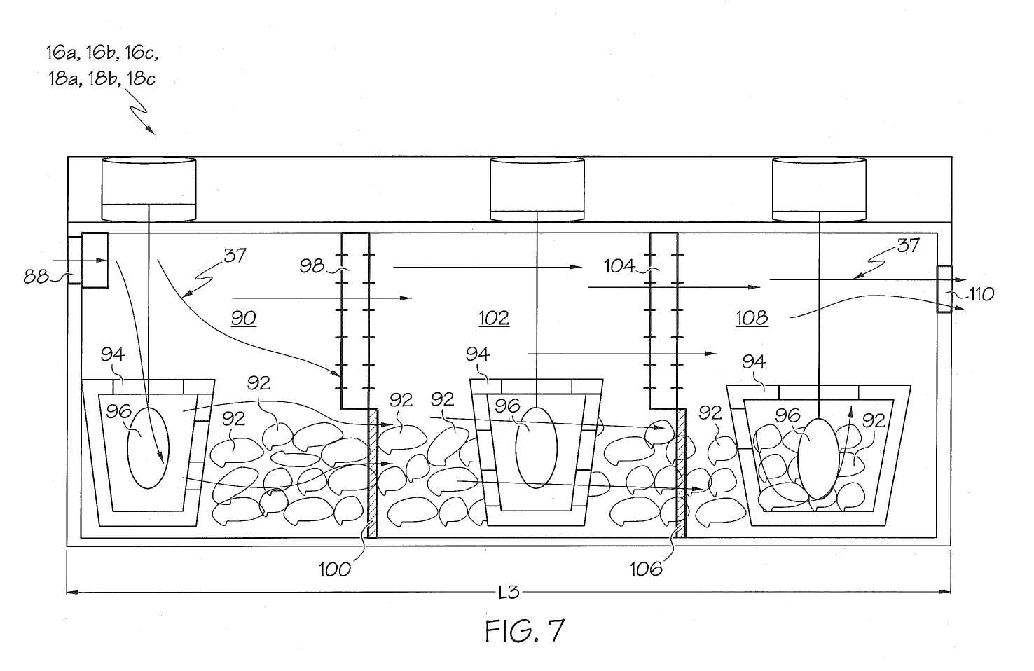

FIG. 7 shows second and third intermediate barges 16a-16c and 18a-18c, which may be of identical construction. Upon entering the second and third intermediate barges 16a-16c and 18a-18c through the inlet ports 88, the water 37 passes through a seventh tank 90 which may include calcium carbonate 92 therein. Concrete containment basins (CCBs) or other suitable containers 94 may be included within the seventh tanks 90. In one embodiment, the containers 94 each include a filter 96 which may be in the form of a hanging bag containing pollutant collection substrates such as silicon dioxide (SiO₂), calcium carbonate (CaCO₃). cadmium (Cd) and Bismuth-210 (Bi) to absorb chloride ions (Cl⁻) and neutrons, including neutrons of barium (Ba). As shown using arrows indicating the flow of the contaminated water 37, at least a portion of the water 37 flowing through the seventh tank 90 may flow through the containers 94 and be exposed to the one or more substrates in the hanging bags 96. After flowing through the seventh tanks 90, at least a portion of the water 37 passes through a fifth baffle 98 that may also include one or more substrates, such as silicon dioxide (SiO₂), calcium carbonate (CaCO₃) and cadmium (Cd). The other portion of the water 37 may pass underneath the fifth baffle 98 through one or more stainless steel screens 100 that contain palladium (Pd) or other suitable substances having a desired treating effect or material property.

Upon passing through the fifth baffle 98 or the one or more screen 100, the water 37 enters an eighth tank 102 which, like the seventh tank 90, may include calcium carbonate 92 and containers 94 therein having hanging one or more substrate bags 96. As shown, at least a portion of the water 37 passing through the eighth tanks 102 may flow through the containers 94 and be exposed to the substrates in the hanging bags 96. After flowing through the eighth tank 102, at least a portion of the water 37 passes through a sixth baffle 104 that can contain one or more substrates similar to the other baffles 98, 70, 62, 48 and 40. The other portion of the water 37 may pass underneath the sixth baffle 104 through stainless steel screens 106 that contain palladium (Pd) or other suitable substances having a desired treating effect or material property.

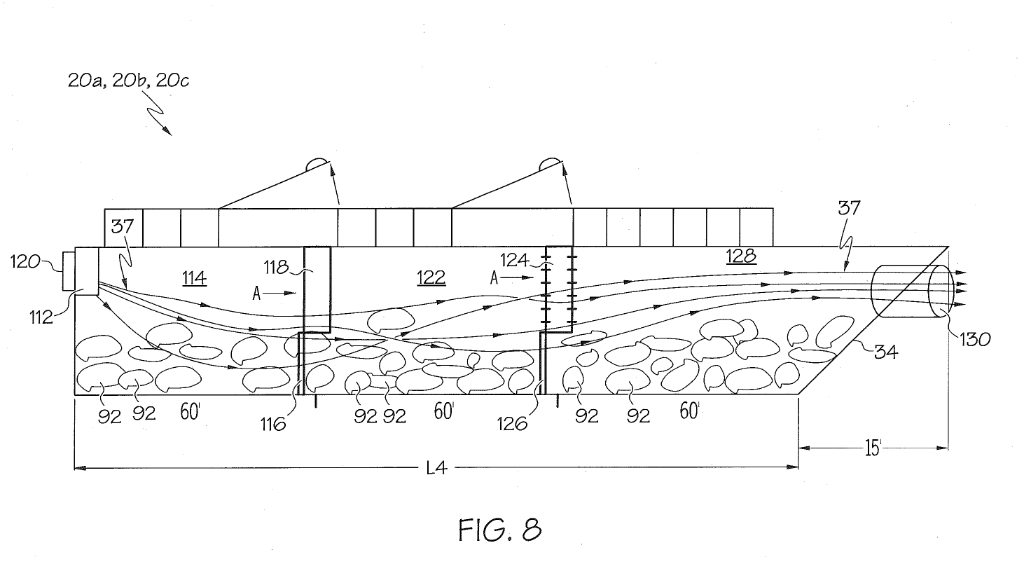

Upon passing through the sixth baffles 104 or screens 106, the water 37 enters a ninth tank 108, which, like the seventh and eighth tank 90 and 102, may also include calcium carbonate 92 and containers 94 therein having hanging substrate bags 96. As shown, at least a portion of the water 37 passing through the ninth tank 108 may flow through the containers 94 and be exposed to the substrates in the hanging bags 96. After flowing through the ninth tank 108, the water 37 exits via outlet ports 110. In the case of the second intermediate barges 16a-16c, the water 37 then flows into inlet ports 88 of the third intermediate barges 18a-18c. In the case of the third intermediate barges 18a-18c, the water 37 then flows into one or more inlet ports 112 of the rear barges 20a-20c (see FIG. 8).

As depicted in FIG. 8, upon entering the rear barges 20a-20c through the one or more inlet port 112, the water 37 passes through a tenth tank 114 and then screens 116 located under a diverting wall 118 into an eleventh tank 122. The inlet ports 112 may be equipped with backflow prevention devices 120, one-way valves or check valves in order to prevent the water 37 in the rear barges 20a-20c from reentering the third intermediate barges 18a-18c. After flowing through the eleventh tank 122, at least a portion of the water 37 passes through a seventh baffle 124 that may contain one or more substrates similar to baffles 40, 48, 62, 70, 98 and 104 described above. The other portion of the water 37 may pass underneath the seventh baffle 124 through one or more screens 126. As shown, the tenth, eleventh and twelfth tanks 114, 122 and 128 may additionally include calcium carbonate 92 or other substance located therein suitable for polishing the water 37. The rear barges 20a-20c include outlet ports 130 through which the water 37 may be discharged. The rear barges 20a-20c may be placed under vacuum by the vacuum system 132 located on the tugboat 26 (see FIG. 2).

Upon discharge from the rear barges 20a-20c, the water 37 can be diverted in the vacuum system 132 after it is received in one or more inlet ports 134 of the vacuum system 132 as best illustrated in FIG. 3. Vacuum system 132 may be disposed on the tugboat as shown in FIG. 3, or may alternatively be disposed on one of the barges of the system or another vessel. The water may also be diverted to a sampling device to ensure it has been properly treated. The chemical properties of water 37 may be constantly monitored in the sampling device (not shown) during its treatment and depending upon the flow rate of water through the system and the types of pollutants in the water, the amount and volume of treatment chemicals can be adjusted by increasing, decreasing the amount or changing the type or order of the treatment chemicals. The process of adjusting the treatment chemicals can optionally be automated and undertaken by a computerized system. The computerized system may be connected to a sampling device (not shown) and real-time adjustment of the treatment process may be made. As shown in FIG. 2, from the vacuum system 132, some or all of the treated water may be discharged from a first port 136 and diverted to other barges (not shown) or railcars (not shown) for transport to other sites, for example to fracking sites. Likewise, some or all of the treated water may be discharged from second ports 138 and diverted back to the body of water (e.g., river) downstream or upstream from the area of treatment depending upon the direction of travel of the system 10.

It will be appreciated that other water treatment systems and methods may be provided on the barges 12a-20c. For example, the barges 12a-20c may be equipped with additional filters, aerators, basin, substances, chemicals and other systems depending upon the type of contaminants present in the water being treated.

From the foregoing, it will be seen that this invention is one well adapted to attain all the ends and objects hereinabove set forth together with other advantages which are obvious and which are inherent to the structure. It will be understood that certain features and sub combinations are of utility and may be employed without reference to other features and sub combinations. This is contemplated by and is within the scope of the claims. Since many possible embodiments of the invention may be made without departing from the scope thereof, it is also to be understood that all matters herein set forth or shown in the accompanying drawings are to be interpreted as illustrative and not limiting. It will also be appreciated the components of the system need not be in the order shown in the figures and described above. Rather, depending upon the water to be treated, the components may be aligned or arranged in a different order. In some embodiments, some of the components may be bypassed if certain types of treatment are not necessary. In other embodiments, the water may be cycled through one or more of the components multiple times in order to achieve necessary purification levels.

The constructions described above and illustrated in the drawings are presented by way of example only and are not intended to limit the concepts and principles of the present invention. Thus, there has been shown and described several embodiments of a novel invention. As is evident from the foregoing description, certain aspects of the present invention are not limited by the particular details of the examples illustrated herein, and it is therefore contemplated that other modifications and applications, or equivalents thereof, will occur to those skilled in the art. The terms “having” and “including” and similar terms as used in the foregoing specification are used in the sense of “optional” or “may include” and not as “required”. Many changes, modifications, variations and other uses and applications of the present construction will, however, become apparent to those skilled in the art after considering the specification and the accompanying drawings. All such changes, modifications, variations and other uses and applications which do not depart from the spirit and scope of the invention are deemed to be covered by the invention which is limited only by the claims which follow.

What is claimed is:

1. A mobile floating water treatment system comprising:
a plurality of floating barges coupled together;
at least one barge having one or more interior tank that receives a volume of water including one or more contaminants;
at least one baffle disposed in said one or more interior tank through which at least a portion of said volume of water passes, said baffle including a substrate material suitable for removing said one or more contaminants; and
a tugboat for mobilizing said plurality of barges.

2. The water treatment system of claim 1, wherein said substrate material includes at least one of calcium carbonate, silicon dioxide, cadmium or Bismuth.

3. The water treatment system of claim 1, wherein said baffle may be selectively raised from said interior tank and provided with additional substrate material.

4. The water treatment system of claim 1 wherein at least one of said one or more interior tank includes an oil snout disposed in one of said one or more interior tank for capturing at least one of oil or benzene from said volume of water.

5. The water treatment system of claim 1 further comprising at least one of a vessel or a railcar located adjacent to said at least one barge having said one or more interior tank; and wherein at least one or more contaminants separated from said volume of water may be diverted to one of said vessel or said railcar for at least one of storage, transportation or disposal.

6. The water treatment system of claim 1 further comprising a dredge in fluid communication with said at least one barge having said one or more interior tank, said dredge collects and feeds said volume of water to said at least one barge having said one or more interior tank.

7. The water treatment system of claim 1, wherein said plurality of barges comprises fifteen barges arranged in a configuration of three barges wide and five barges deep.

8. The water treatment system of claim 1, wherein said plurality of barges comprises forty barges arranged in a configuration of five barges wide and eight barges deep.

9. The water treatment system of claim 1 further comprising:
a vacuum system disposed on one of a vessel, one of said plurality of floating barges, or said tugboat, said vacuum system having an inlet and at least one outlet;
said one or more interior tank of said at least one barge having an inlet port and an outlet port; and
wherein said inlet of said vacuum system is in fluid communication with said outlet port of said one or more interior tank so that said vacuum system receives at least a portion of said volume of water from said one or more interior tank.

10. The water treatment system of claim 9 further comprising said vacuum system including a sampling device for monitoring one or more chemical properties of a sample of said at least a portion of said volume of water received from said one or more interior tank.

11. The water treatment system of claim 10 further comprising a control system in communication with said sampling device for adjusting one or more treatment parameters of said water treatment system based upon one or more said chemical properties of said sample.
